(19) United States
(12) Patent Application Publication
(10) Pub. No.: US 2008/0124587 A1
(43) Pub. Date: May 29, 2008

(54) ELECTRICALLY CONDUCTIVE, HYDROPHILIC AND ACID RESISTANT FILM

(75) Inventors: David Kisailus, Venice, CA (US); Thomas B. Stanford, Oxnard, CA (US); Tina T. Salguero, Encino, CA (US); Jennifer J. Zinck, Calabasas, CA (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/563,372

(22) Filed: Nov. 27, 2006

(51) Int. Cl. H01M 8/00; B05D 5/12

(52) U.S. Cl. 429/12; 427/115

(57) ABSTRACT

A metallic plate for fuel cell application includes a chemically modified metal oxide coating. The modified metal oxide coating advantageously has a predetermined contact angle and is electrically conductive. A method of forming the modified metal oxide includes treating an unmodified oxide with a chemical solution and/or by heating.

### BACKGROUND OF THE INVENTION

1. Field of the Invention

In at least one embodiment, the present invention is related to bipolar plates used in PEM fuel cells.

2. Background Art

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”), to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ionically conductive polymer membrane to the cathode where they combine with oxygen to form water, which is discharged from the cell. The MEA is sandwiched between a pair of porous gas diffusion layers (“GDL”), which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

In addition to high electrical conductivity, the metallic plates used in fuel cell applications require chemical resistivity. For example, the bipolar plate of the hydrogen fuel cell demands strict performance metrics in wettability, electrical conductivity, and corrosion resistance. Currently, passive oxide coatings such as nanoparticulate silicas, or organic-based particles are used as coatings to provide a path for water to be removed from the plate (thus, preventing flooding). However, these coatings are unstable over time, do not adhere well to substrate materials (such as stainless steel), and are non-conductive. Therefore, electrically conductive coatings are usually coated onto passive oxide coatings to minimize the contact resistance. Such electrically conductive coatings include gold and polymeric carbon coatings. Therefore, these coatings require expensive equipment that adds to the cost of the finished bipolar plate.

Accordingly, there is a need for improved methodology for lowering the contact resistance at the surfaces of bipolar plates used in fuel cell applications.

### SUMMARY OF THE INVENTION

The present invention overcomes the problems encountered in the prior art by providing in at least one embodiment a bipolar plate useful for fuel cell assemblies. The bipolar plate of this embodiment includes a metallic substrate with a chemically modified metal oxide coating applied thereto. The metallic substrate has a first and second surface. The first surface defines one or more first surface channels. The chemically modified metal oxide coating is disposed over at least a portion of the first surface such that a portion of first surface defining the one or more first channels is coated with the modified oxide coating. The modified metal oxide coating advantageously has a predetermined contact angle and is electrically conductive. The modified metal oxide coating can be display hydrophobic (contact angle>90°) or hydrophilic (contact angle<30°) behavior and can transport fluids (polar or non-polar depending on surface treatments) over its surface due to enhanced surface wetting. Moreover, the hydrophilic or hydrophobic nature of the chemically modified metal oxide coatings influence contamination and/or moisture resistance.

In another embodiment of the present invention, a method of preparing the metallic bipolar plates set forth above for use in a fuel cell having an anode diffusion layer, an anode, a cathode, and a cathode diffusion layer is provided. The modified metal oxide coatings are synthesized using a low-temperature, solvothermal route. Wetting of the surface is controlled by exposure of coatings to an acidic environment, which renders it hydrophilic. The unique structure of these coatings combined with their tailorable surface chemistries make them useful in a wide variety of chemical environments.

In yet another embodiment of the present invention, a fuel cell incorporating the bipolar plates of the embodiments set forth above are provided.

### BRIEF DESCRIPTION OF THE DRAWINGS

FIG. 1 is a perspective view of a fuel cell incorporating the electrocatalyst of an embodiment of the present invention;

FIG. 2 is a cross-sectional view of an embodiment of the bipolar plate of the invention;

FIG. 3 is a flow diagram illustrating a method of making an embodiment of the bipolar plates of the invention;

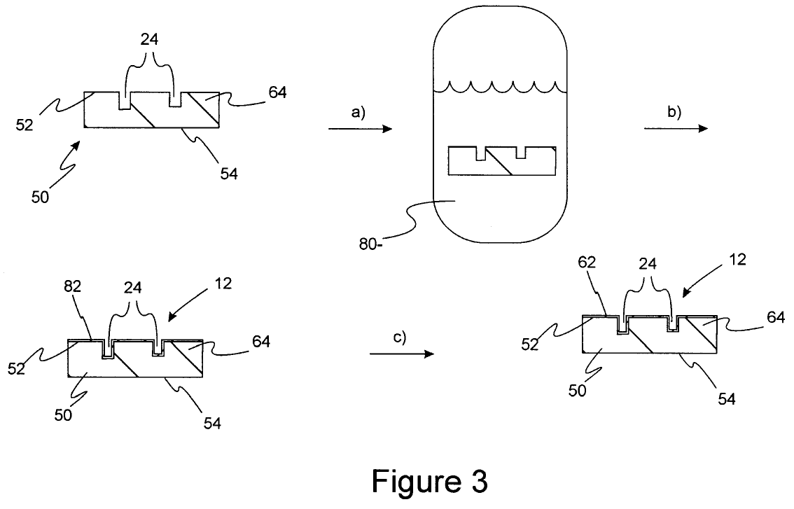

FIG. 4 provides plots of the contact resistance for ruthenium oxide modified in accordance to an embodiment of the invention; and

FIG. 5 is a plot of the spreading distance versus time in a corrosion bath for a ruthenium oxide coating modified in accordance to an embodiment of the invention.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

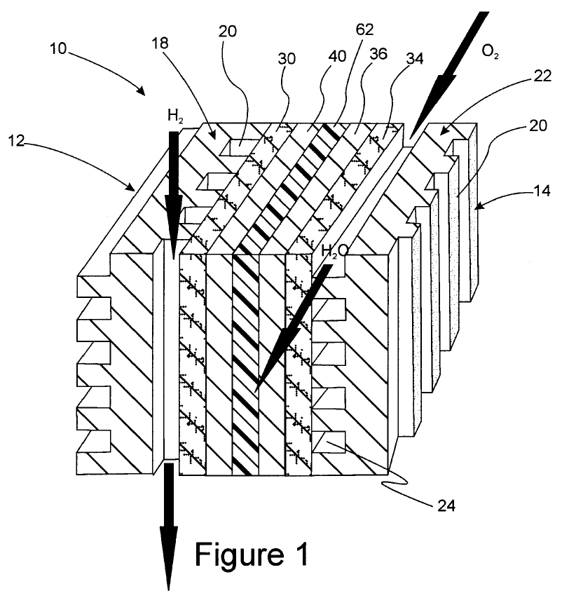

With reference to FIG. 1, a perspective view of a fuel cell incorporating the bipolar plates of the present embodiment is provided. PEM fuel cell 10 includes bipolar plates 12, 14 of an embodiment of the present invention. Within bipolar plate 12, anode flow field 18 includes one or more channels 20 for introducing a first gas to the fuel cell 10. Similarly, bipolar plate 14 includes cathode gas flow field 22, which includes one or more channels 24 for introducing a second gas into fuel cell 10. Typically, the first gas includes a fuel such as hydrogen while the second gas includes an oxidant such as oxygen. Anode diffusion layer 30 is positioned between anode flow field 18 and anode layer 32 while cathode diffusion layer 34 is positioned between cathode flow field 22 and cathode layer 36. Polymeric ion conductive membrane 40 is interposed between anode layer 32 and cathode layer 36.

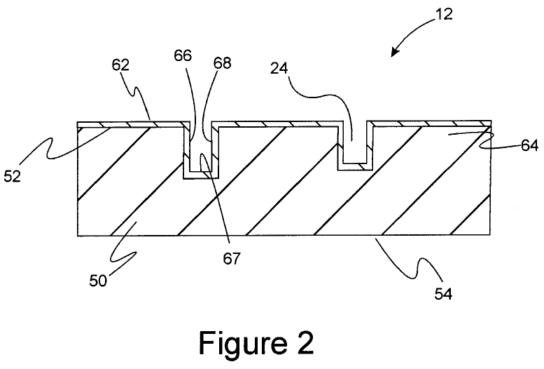

With reference to FIG. 2, a schematic illustration of a variation of the bipolar plates of the invention that uses electrically conductive particles as the conductive material is provided. Bipolar plate 12 includes metal plate 50, which has first surface 52 and second surface 54. At least one of first surface 52 or second surface 54 defines one or more channels 24. Modified metal oxide coating 62 is disposed over one or both of first and second surfaces 52, 54. It should also be appreciated that in particular sides 66, 67, 68 of channels 24 are coated with modified metal oxide coating 62 to assist in water removal from the fuel cell when modified metal oxide coating 62 is hydrophilic.

In a variation of the present embodiment, modified metal oxide coating 62 includes uniformly distributed and sized nanocrystals. In another variation, modified metal oxide coating 62 exhibits extremely low contact resistances (<50 mohm-cm²) compared to stainless steel when incorporated in fuel cells in which a diffusion layer is contacted by one or both of first and second surfaces 52, 54. In a refinement of this variation, the contact resistance is from about 0 to about 20 mohm-cm². In another refinement, the contact resistance is from about 0 to about 50 mohm-cm². Typically, modified metal oxide coating 62 shows extended resistance to acidic corrosive environments.

Modified metal oxide coating 62 is formed by contacting an unmodified metal oxide coating with a chemical agent as set forth below. In general, the unmodified metal oxide coating has an initial contact angle that is altered by the chemical agent. Moreover, the unmodified metal is chemically modified to adjust the surface energy properties while still maintaining high electrical conductivity. In one variation, this modification results from treatment with an acid solution. In some variations, this acid treatment results in the modified metal oxide having a plurality of acid residues that the predetermined contact angle of the modified metal oxide coating is at least partially determined by the concentration of acid residues. The term “acid residue” refers the chemical species present after treatment with an acid solution. In a variation of the present embodiment, modified metal oxide 62 coating has a contact angle less than or equal to 50. In another variation of the present embodiment, modified metal oxide 62 coating has a contact angle greater than or equal to 50. In another variation of the present invention, modified metal oxide coating 62 has a contact angle that is between 1 and 30.

The modified metal oxide is typically a modified conductive metal oxide with a conductivity greater than about 100 S/cm. Examples of such conductive oxides include ruthenium oxides, tin oxide, doped tin oxides, doped titanium oxides, zinc oxide, doped zinc oxides, and combinations thereof. Using a material such as ruthenium oxide, which is in nature hydroxyl-free due to the cation's (ruthenium) strong polarization potential, results in hydrophobic surface.

In another embodiment of the present invention, a method for making the bipolar plate set forth above is provided. The method of this embodiment comprises contacting metal plate 50 with solution 80 that contains a metal oxide forming-precursor in step a). In step b), the temperature and pressure of solution 80 is adjusted to sufficient values for forming metal oxide coating 82 covering at least a portion of the metal plate 50. Typically, step b) is performed in sealed reaction vessel 84 by heating the solution and metallic substrate contained therein. In one refinement of the present embodiment, step b) is performed a pressure greater than about 50 psi. In another refinement of the present embodiment, step b) is performed a pressure from 1 psi to 300 psi. Typically, during step b), solution 80 is heated to a temperature from 100° C. to 600° C. for 1 to 72 hours. In general, modified metal oxide coating 62 has a different contact angle than an unmodified metal oxide coating 82.

In one variation of the present embodiment, metal oxide coating 82 is contacted with a chemical agent to effect the change in contact angle. In one refinement, metal oxide coating 82 is contacted with an acidic solution for a sufficient time to form modified metal oxide coating 62 in step c). Typically, in this variation, step c) is performed at a temperature greater than 100° C. In another refinement, step c) is performed at a temperature from 50° C. to 350° C. In still another refinement of the present variation, step c) is performed a pressure greater than about 50 psi. In yet another refinement, step c) is performed a pressure from 1 psi to 300 psi. Typically, step c) is performed with a timer duration of about 10 minutes to 16 hours.

In another variation of the present embodiment, metal oxide coating 82 is heated for a sufficient time to form modified metal oxide coating 62. This step may be performed along with the step of treating the unmodified oxide with a chemical agent or in place of that step. The heating of this variation is typically at a temperature from about 150° C. to about 500° C. for no less than 15 seconds up to about 24 hours.

As set forth above, the modified metal oxide is typically a modified conductive metal oxide. Therefore, metal oxide-forming precursor comprises a conductive metal oxide precursor and in particular, a ruthenium oxide-forming precursor. Specific examples of ruthenium oxide-forming precursor have a metal such as ruthenium and ligands attached thereto. Examples of such ligands include, but are not limited to, acetyl acetonates (“AcAc”) and chloride (e.g., ruthenium chloride).

In a variation of the present invention, solution 80 further comprises an oxygen-containing compound. Examples of such oxygen containing compounds include, but are not limited to, alcohols, water, and combinations thereof. The oxygen containing compounds typically provide at least a portion of the oxygen in the metal oxide coating formed above.

The following examples illustrate the various embodiments of the present invention. Those skilled in the art will recognize many variations that are within the spirit of the present invention and scope of the claims.

A precursor solution is prepared as follows. A ruthenium salt (ruthenium acetyl acetonate or ruthenium chloride) is dissolved in a compatible solvent (either toluene/ethanol or water, respectively). The precursor solution (15 mL) is then placed in a Teflon® lined vessel (23 mL in this reaction, but can be altered to other volumes). A substrate coupon (a 316 stainless steel piece of any geometry and thickness roughened by sand blasting in this) is cleaned with detergents (alkanox) in water followed by a thorough DI water rinse. The substrate is then cleaned in a beaker with acetone (ultrasonically agitated) followed by immersion into a beaker of ethanol (agitated by ultrasonication). After the final ethanol cleaning, the substrate is then placed in the precursor solution contained in the Teflon® vessel. The Teflon® vessel with the stainless steel coupon is then sealed and placed in a stainless steel pressure vessel (Parr, Inc). The entire apparatus (stainless steel vessel containing the Teflon® lined vessel which contains the substrate immersed in the precursor solution) is then placed in an oven and heated to a temperature from about 180° C. to 250° C. for a time between 6 hours and 72 hours. (Typical conditions are 200° C., 18 hours). After a predetermined time, the apparatus is removed from the oven and cooled. The vessel is opened and the coated substrate is removed. The coated substrate is then placed in an acid bath at 80° C. for at least 1 hour (but usually 16 hours). The acid bath consists of the following: 1.8 ppm HF, 12.5 ppm H₂SO₄, 0.05M KH₂PO₄. Alternatively, after removal from the vessel. the coated substrate is placed on a hot plate heated between 150° C.-350° C. from 15 seconds-24 hours.

As illustrated in Table 1, the electrically conductivity of the RuO₂ films of this invention remains quite stable and nearly invariant after 16 hrs exposure to the corrosion bath. Table 1 demonstrates that the modified metal oxide coating of an embodiment of the present invention have a surface energy as measured by the contact angle that is significantly reduced compared to untreated coating. Thus, not only are there films rendered superhydrophilic which enable enhanced removal of water, but they are chemically stable and maintain their low resistivity even in chemically harsh environments that may potentially be found in the fuel cell.

| | Before | | | After | | |
|---|---|---|---|---|---|---|
| | Pres- | Contact | | Pres- | Contact | Con- |
| | sure, | resistance, | Contact | sure, | resistance, | tact |
| | psi | ohm-cm2 | angle | psi | ohm-cm2 | angle |
| RuO₂ (AcAc, | 200 | 33 | 108 | 200 | 36 | 5 |
| solvothermal, 6 | | | | | | |
| hours at 200° C. | | | | | | |
| RuO₂ (AcAc, | 200 | 21 | 112 | 217 | 20 | 6 |
| solvothermal, 72 | | | | | | |
| hours at 200° C. | | | | | | |

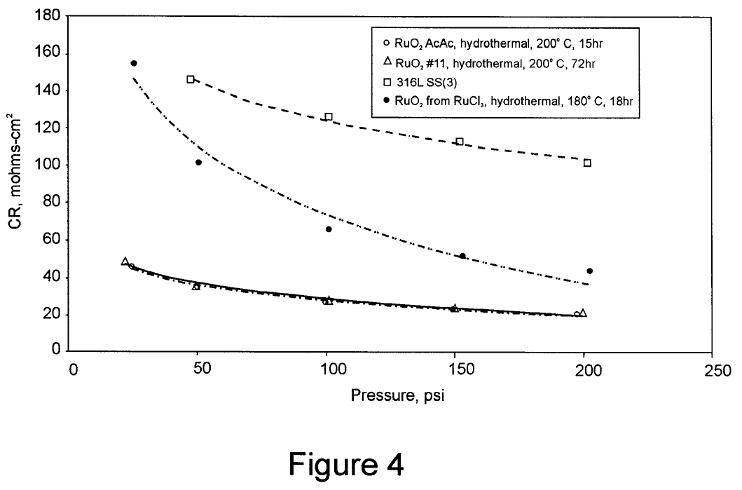

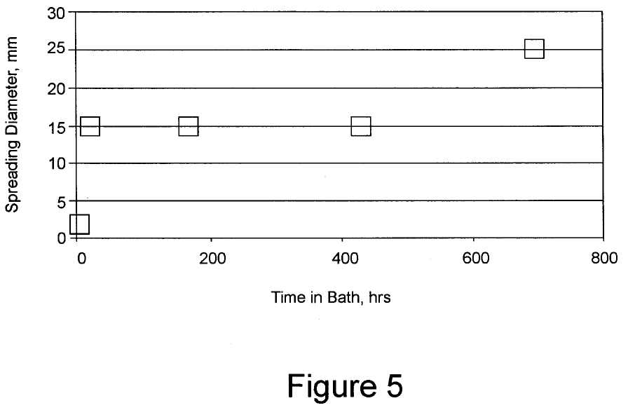

FIG. 4 provides plots of the contact resistance for ruthenium oxide modified in accordance to embodiments of the invention. FIG. 4 provides a contact resistance plot for RuO₂ made from RuAcAc by a solvothermal method at 200° C. for 18 and 72 hours, provides a contact resistance plot RuO₂ made from RuCl₃, by a hydrothermal method at 180° C. for 18 hours, and a contact resistance plot for 316L SS. It is clear that the deposited RuO₂ coating results in a significant reduction in the contact resistance versus an uncoated stainless steel plate. Thus, a one step coating process provides the plate with a superhydrophilic surface that has superior conductivity and acid resistance. FIG. 5 provides a plot of the spreading distance versus time in a corrosion bath. Spreading distance is the diameter that a 10 microliter droplet of water will spread in 10 seconds. Thus, treating the as-synthesized film in an acidic bath or by thermally annealing will remove any residual organic and hydrolyze the surface of the RuO₂, which results in a superhydrophilic film that enhances the wettability of water as demonstrated in FIG. 5. Enhancement of this wettability will allow water to flow off the bipolar plate in an efficient and fast manner.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method of forming a bipolar plate from a metallic substrate, the metallic substrate having one or more channels useful for fuel cells assemblies, the method comprising:
a) contacting the metallic substrate with a solution having a metal oxide forming-precursor;
b) adjusting the temperature and pressure of the solution to sufficient values for forming a metal oxide coating covering at least a portion of the metallic substrate; and
c) contacting the metal oxide coating with an acidic solution for a sufficient time to form a modified metal oxide coating, the modified metal oxide coating having a contact angle a predetermined value at a surface of the one or more channels.

2. The method of claim 1 wherein the modified metal oxide coating has a contact angle less than or equal to 500.

3. The method of claim 1 wherein the modified metal oxide coating has a contact angle less between 1° and 30°.

4. The method of claim 1 wherein the modified metal oxide coating has a contact angle greater than or equal to 50°.

5. The method of claim 1 wherein step b) is performed in a sealed reaction vessel by heating the solution and metallic substrate contained therein.

6. The method of claim 1 wherein the metal oxide-forming precursor comprises a conductive oxide-forming precursor.

7. The method of claim 1 wherein the metal oxide-forming precursor comprises a ruthenium oxide-forming precursor.

8. The method of claim 7 wherein the ruthenium oxide-forming precursor comprises ruthenium and a ligand.

9. The method of claim 1 wherein the solution further comprises an oxygen-containing compound.

10. The method of claim 1 wherein the oxygen-containing compound comprises a component selected from the group consisting of an alcohol, water, and combinations thereof.

11. The method of claim 1 wherein step c) is performed a temperature greater than 100° C.

12. The method of claim 1 wherein step c) is performed a pressure greater than about 50 psi.

13. The method of claim 1 wherein step c) is performed a pressure from 1 psi to 300 psi.

14. A method of forming a bipolar plate from a metallic substrate, the metallic substrate having one or more channels useful for fuel cells assemblies, the method comprising:
a) contacting the metallic substrate with a solution having a metal oxide forming-precursor;
b) adjusting the temperature and pressure of the solution to sufficient values for forming a metal oxide coating covering at least a portion of the metallic substrate; and
c) heating the metal oxide coating to a sufficient temperature for an adequate time period to form a modified metal oxide coating, the modified metal oxide coating having a contact angle a predetermined value at a surface of the one or more channels.

15. The method of claim 14 wherein the modified metal oxide coating has a contact angle less between 1° and 30°.

16. The method of claim 1 wherein step b) is performed in a sealed reaction vessel by heating the solution and metallic substrate contained therein.

17. The method of claim 1 wherein the metal oxide-forming precursor comprises a conductive oxide-forming precursor.

18. The method of claim 1 wherein the metal oxide-forming precursor comprises a ruthenium oxide-forming precursor.

19. A bipolar plate for fuel cell assemblies, the bipolar plate comprising:
a metallic substrate having a first and second surface, the first surface defining one or more first surface channels; and
a modified metal oxide coating disposed over at least a portion of the first surface such that a portion of first surface defining the one or more first channels is coated with the modified oxide coating, the modified metal oxide coating having a predetermined contact angle.

20. The bipolar plate of claim 19 wherein the modified metal oxide comprising a plurality of acid residues.

21. The bipolar plate of claim 20 wherein the predetermined contact angle is at least partially determined by the concentration of acid residues.

22. The bipolar plate of claim 19 wherein the modified metal oxide coating has a different contact angle than an unmodified metal oxide coating.

23. The bipolar plate of claim 19 wherein the modified metal oxide coating is formed by contacting an unmodified metal oxide coating with a chemical agent, the unmodified metal oxide coating having an initial contact angle that is altered by the chemical agent.

24. The bipolar plate of claim 23 wherein the chemical agent comprise an acidic solution.

25. The bipolar plate of claim 19 wherein the modified metal oxide coating has a contact angle less than or equal to 50°.

26. The bipolar plate of claim 19 wherein the modified metal oxide coating has a contact angle less between 1° and 30°.

27. The bipolar plate of claim 19 wherein the modified metal oxide coating has a contact angle greater than or equal to 50°.

28. The bipolar plate of claim 19 wherein the modified metal oxide comprises a metal oxide selected from the group consisting of ruthenium oxides, tin oxide, doped tin oxides, doped titanium oxides, zinc oxide, doped zinc oxides, and combinations thereof.

29. The bipolar plate of claim 19 wherein the second surface defines one or more second surface channels such that at least a portion of the second surface is coated with the modified oxide coating.

30. A fuel cell comprising:
a first bipolar plate;
an anode diffusion layer contacting the first bipolar plate at a first contacting interface;
an anode layer;
a ion conductor layer;
a cathode;
a cathode diffusion layer; and
a second metallic bipolar plate contacting the cathode diffusion layer at a second contacting interface, wherein one or both of the first and second metallic plates comprise a metal plate having a first and second surface such that at least one of the first and second surfaces defines one or more channels coated with a modified oxide coating, the modified oxide coating having a predetermined contact angle.

31. The fuel cell of claim 30 wherein the modified metal oxide comprising a plurality of acid residues.

32. The fuel cell of claim 30 wherein the predetermined contact angle is at least partially determined by the concentration of acid residues.

33. The fuel cell of claim 30 wherein the modified metal oxide coating has a different contact angle than an unmodified metal oxide coating.

34. The fuel cell of claim 30 wherein the modified metal oxide coating has a contact angle greater than or equal to 50°.

35. The fuel cell of claim 30 wherein the modified metal oxide coating has a contact angle less than or equal to 50°.

36. The fuel cell of claim 30 wherein the modified metal oxide coating has a contact angle less between 1° and 30°.
